(19) United States
(12) Patent Application Publication
(10) Pub. No.: US 2026/0184294 A1
(43) Pub. Date: Jul. 2, 2026

(54) APPARATUS FOR CONTROLLING A VEHICLE, AND METHOD THEREOF

(71) Applicants: HYUNDAI MOTOR COMPANY, SEOUL (KR); KIA CORPORATION, SEOUL (KR)

(72) Inventors: Jae Il Park, Hwaseong-si (KR); Kyung Hyun Kim, Hwaseong-si (KR); Sheen Gil Kang, Hwaseong-si (KR); Jang Hun Jeong, Hwaseong-si (KR)

(73) Assignees: HYUNDAI MOTOR COMPANY, SEOUL (KR); KIA CORPORATION, SEOUL (KR)

(21) Appl. No.: 19/221,793

(22) Filed: May 29, 2025

(30) Foreign Application Priority Data
Dec. 26, 2024 (KR) 10-2024-0197165

(51) Int. Cl. B60W 10/08; B60W 50/16

(52) U.S. Cl. CPC B60W 10/08; B60W 50/16; B60W 2510/083; B60W 2540/215

(57) ABSTRACT

A vehicle control apparatus may include a sensor that senses a driver input and is mounted on a vehicle, and a processor that controls a driving motor of the vehicle. The processor may provide the driver input to a user terminal in a virtual driving mode, may receive virtual driving information obtained by performing virtual vehicle driving based on the driver input, and may generate torque for controlling the driving motor based on the virtual driving information.

### CROSS-REFERENCE TO RELATED APPLICATION

This application claims the benefit of priority to Korean Patent Application No. 10-2024-0197165, filed in the Korean Intellectual Property Office on Dec. 26, 2024, the entire contents of which are incorporated herein by reference.

### TECHNICAL FIELD

The present disclosure relates to a vehicle control apparatus and a method thereof, and more specifically, relates to a technology capable of controlling the motion of a vehicle in conjunction with a game.

### BACKGROUND

Vehicles being primary transportation are increasingly being used for purposes other than transportation. For example, infotainment is a compound word of information and entertainment, and refers to a device that provides information and audio and visual entertainment. Nowadays, with the advancement of technologies of telematics, connected cars, and autonomous driving car, the use of in-vehicle infotainment systems (IVI) is increasing.

However, an infotainment system remains at a level of utilizing multimedia devices installed in a vehicle.

Nowadays, electric vehicles are increasingly demanded. An electric vehicle may charge electrical energy from an external power source to a battery included in the vehicle, and may drive a drive motor by using the charged electrical energy to drive the vehicle. Due to differentiating features from an internal combustion engine, electric vehicles are being actively researched to use other functions in addition to driving.

### SUMMARY

The present disclosure was made to solve the above-mentioned problems occurring in the prior art while advantages achieved by the prior art are maintained intact.

An aspect of the present disclosure provides a vehicle control apparatus capable of providing an occupant of a vehicle with a specific impact of an application running on a terminal outside the vehicle, and a method thereof.

An aspect of the present disclosure provides a vehicle control apparatus capable of increasing the immersion of a game executed by the occupant of the vehicle through the terminal, and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle control apparatus may include a sensor that senses a driver input and is mounted on a vehicle, and a processor that controls a driving motor of the vehicle. The processor may provide the driver input to a user terminal in a virtual driving mode, may receive virtual driving information obtained by performing virtual vehicle driving based on the driver input, and may generate torque for controlling the driving motor based on the virtual driving information.

According to an embodiment, the processor may maintain the virtual driving mode based on an index signal, of which a value is changed at a specific interval while the virtual vehicle driving is running from the user terminal.

According to an embodiment, the processor may restrict entry into the virtual driving mode when the vehicle is driving or an incline of the vehicle is greater than or equal to a specific level.

According to an embodiment, the processor may restrict the driving motor from being driven based on driver-required torque in the virtual driving mode.

According to an embodiment, the processor may perform a motion impact by controlling the driving motor such that a front wheel and a rear wheel of the vehicle rotate in opposite directions to each other in the virtual driving mode.

According to an embodiment, the processor may generate a first torque for the motion impact when a gear shift is detected in the virtual vehicle driving.

According to an embodiment, the processor may determine a Z-axis movement of the vehicle from the virtual driving information, and may generate a second torque for the motion impact based on the Z-axis movement.

According to an embodiment, the processor may determine an impact amount from the virtual driving information, and may generate a third torque for the motion impact based on the impact amount.

According to an embodiment, the processor may select a preferred torque among the first torque, the second torque, and the third torque based on a predetermined priority, and may perform the motion impact based on the preferred torque.

According to an embodiment, the processor may control the driving motor based on initial torque during a period of the virtual driving mode and may execute the motion impact by adding the initial torque and the preferred torque when the preferred torque is determined.

According to an aspect of the present disclosure, a vehicle control method may include providing, by a processor, a driver input to a user terminal, receiving, by the processor, virtual driving information, which is obtained by performing virtual vehicle driving based on the driver input, from the user terminal in a virtual driving mode, and generating, by the processor, torque for controlling the driving motor of the vehicle based on the virtual driving information.

According to an embodiment, the receiving of the virtual driving information may include maintaining the virtual driving mode based on an index signal, of which a value is changed at a specific interval while the virtual vehicle driving is running from the user terminal.

According to an embodiment, the method may further include restricting entry into the virtual driving mode when the vehicle is driving or an incline of the vehicle is greater than or equal to a specific level.

According to an embodiment, the method may further include restricting the driving motor from being driven based on driver-required torque in the virtual driving mode.

According to an embodiment, the generating of the torque for controlling the driving motor of the vehicle based on the virtual driving information may include performing a motion impact by controlling the driving motor such that a front wheel and a rear wheel of the vehicle rotate in opposite directions to each other.

According to an embodiment, the performing of the motion impact may include generating a first torque for the motion impact when a gear shift is detected in the virtual vehicle driving.

According to an embodiment, the performing of the motion impact may include determining a Z-axis movement of the vehicle from the virtual driving information, and generating a second torque for the motion impact based on the Z-axis movement.

According to an embodiment, the performing of the motion impact may include determining an impact amount from the virtual driving information, and generating a third torque for the motion impact based on the impact amount.

According to an embodiment, the performing of the motion impact may include selecting preferred torque among the first torque, the second torque, and the third torque based on a predetermined priority, and performing the motion impact based on the preferred torque.

According to an embodiment, the performing of the motion impact may include controlling the driving motor based on initial torque during a period of the virtual driving mode, and performing the motion impact by adding the initial torque and the preferred torque when the preferred torque is determined.

### BRIEF DESCRIPTION OF THE DRAWINGS

The above and other objects, features and advantages of the present disclosure will be more apparent from the following detailed description taken in conjunction with the accompanying drawings:

FIG. 1 is a drawing showing an operation of a vehicle control apparatus, according to an embodiment of the present disclosure;

FIG. 2 is a drawing showing a configuration of a vehicle control apparatus, according to an embodiment of the present disclosure;

FIG. 3 is a flowchart for describing a vehicle control method, according to an embodiment of the present disclosure;

FIG. 4 is a diagram for describing a method in which a processor controls a driving motor;

FIG. 5 is a drawing for describing an operation of a processor, according to an embodiment of the present disclosure;

FIG. 6 is a flowchart for describing a procedure for generating first torque;

FIG. 7 is a flowchart for describing a procedure for generating second torque;

FIG. 8 is a flowchart for describing a procedure for generating third torque;

FIG. 9 is a drawing for describing a method for generating final torque for a motion impact;

FIG. 10 is a flowchart for describing a vehicle control method, according to another embodiment of the present disclosure; and

FIG. 11 is a block diagram illustrating a computing system according to an embodiment of the present disclosure.

### DETAILED DESCRIPTION

Hereinafter, some embodiments of the present disclosure will be described in detail with reference to the accompanying drawings. In adding reference numerals to components of each drawing, it should be noted that the same components include the same reference numerals, although they are indicated on another drawing. Furthermore, in describing the embodiments of the present disclosure, detailed descriptions associated with well-known functions or configurations will be omitted when they may make subject matters of the present disclosure unnecessarily obscure.

In describing elements of an embodiment of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms used herein, including technical or scientific terms, include the same meaning as commonly understood by one of ordinary skill in the technical field to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein.

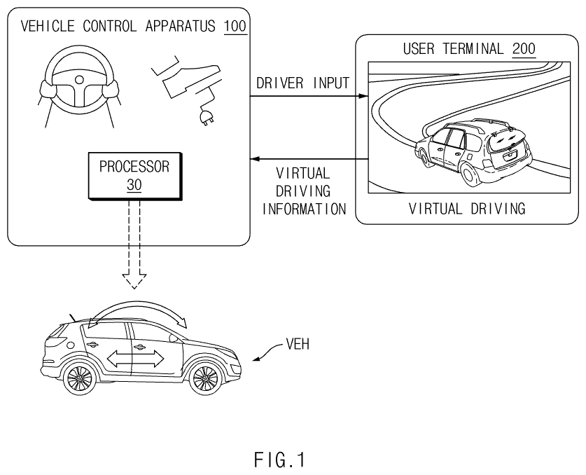

Hereinafter, embodiments of the present disclosure will be described in detail with reference to FIGS. 1 to 11.

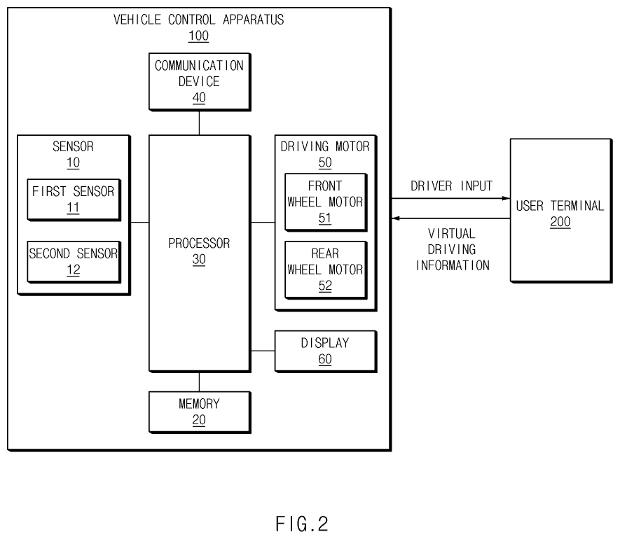

FIG. 1 is a drawing showing an operation of a vehicle control apparatus, according to an embodiment of the present disclosure. FIG. 2 is a drawing showing a configuration of a vehicle control apparatus, according to an embodiment of the present disclosure.

Referring to FIGS. 1 and 2, a vehicle control apparatus 100 according to an embodiment of the present disclosure may be used to operate a vehicle motion effect for virtual driving performed based on a driver input by an occupant of a vehicle VEH.

To this end, the vehicle control apparatus 100 may provide the driver input to a user terminal 200. The user terminal 200 may mean a portable terminal not mounted on a vehicle. The user terminal 200 may perform virtual driving based on the driver input and may transmit virtual driving information to the vehicle VEH. The vehicle VEH may control the motion of the vehicle VEH based on the virtual driving information, thereby increasing the realism of virtual driving.

The vehicle control apparatus 100 according to an embodiment of the present disclosure may be mounted on the vehicle VEH and may include a sensor 10, a memory 20, a processor 30, a communication device 40, a driving motor 50, and a display 60.

The sensor 10 may include a first sensor 11 for obtaining external environment information of the vehicle and a second sensor 12 for obtaining status information of the vehicle.

The first sensor 11 may include a camera, a Light imaging Detection And Ranging (LiDAR), a Radio Detection and Ranging (RADAR), an ultrasonic sensor, and an infrared sensor.

The second sensor 12 may include a sensor for obtaining status information of the vehicle by the driver input. The driver input may include an APS signal and a steering angle operated by a driver riding the vehicle VEH.

The second sensor 12 may include a steering angle sensor, a wheel speed sensor, an acceleration position sensor (APS), a brake position sensor (BPS), and the like. The steering angle sensor may be used to determine a change in the position of a steering wheel according to the operation of the steering wheel, and the wheel speed sensor may be used to determine the speed of the vehicle VEH. The APS may output an acceleration position signal according to the pressing of an accelerator pedal, and the acceleration position signal may be used to determine a driver's required torque. The BPS may output a brake position signal according to the pressing of a brake pedal, and the brake position signal may be used to determine the magnitude of braking force. In addition, the second sensor 12 may further include a yaw rate sensor, a longitudinal acceleration sensor, and the like for determining the movement of the vehicle VEH.

Besides, the second sensor 12 may further include well-known sensors for identifying the driver input.

The memory 20 may store an algorithm for an operation of the processor 30 and an AI processor. The memory 20 may use a hard disk drive, a flash memory, an electrically erasable programmable read-only memory (EEPROM), a static random access memory (SRAM), a ferro-electric RAM (FRAM), a phase-change RAM (PRAM), a magnetic RAM (MRAM), a dynamic RAM (DRAM), a synchronous DRAM (SDRAM), a double date rate-SDRAM (DDR-SDRAM), and the like.

The processor 30 may be connected to the sensor 10, the memory 20, the communication device 40, the driving motor 50, and the display 60 to control the overall operation of the vehicle control apparatus 100. The processor 30 may execute instructions, which are stored in the memory 20 and which are in the form of a computer-readable storage medium, and may perform specific operations based on the execution of the instructions.

According to an embodiment, the processor 30 may identify that the user terminal 200 performs virtual driving, and may operate the vehicle VEH in a virtual driving mode. The processor 30 may provide the driver input to the user terminal 200 in the virtual driving mode. The processor 30 may receive the virtual driving information obtained based on the driver input, and may generate torque for controlling the driving motor 50 based on the virtual driving information.

The torque may mean the magnitude for determining the rotational speed of the driving motor 50, and may include directionality. For example, front and rear wheels may rotate independently. The processor 30 according to an embodiment may determine the torque such that the front and rear wheels rotate in opposite directions to each other.

The communication device 40 may be used to communicate with the user terminal 200 and may include wired or wireless communication protocols.

The communication device 40 may support the short range communication by using at least one of Bluetooth, radio frequency identification (RFID), infrared data association (IrDA), ultra wideband (UWB), ZigBee, near field communication (NFC), Wireless-Fidelity (Wi-Fi), Wi-Fi Direct, or wireless universal serial bus (Wireless USB) technologies.

Moreover, the communication device 40 may include a V2X communication module. The V2X communication module may include an RF circuit for a wireless communication protocol with a server (vehicle to infra (V2I)), another vehicle (vehicle to vehicle (V2V)), or a pedestrian (vehicle to pedestrian (V2P)).

The communication device 40 may exchange a wireless signal with at least one of a base station, an external terminal, or a center on a mobile communication network established according to technical standards or communication methods for mobile communication. For example, the communication device 40 may perform communication based on global system for mobile communication (GSM), code division multi access (CDMA), code division multi access 2000(CDMA 2000 ), enhanced voice-data optimized or enhanced voice-data only (EV-DO), wideband CDMA (WCDMA), high speed downlink packet access (HSDPA), high speed uplink packet access (HSUPA), long term evolution (LTE), or long term evolution-advanced (LTE-A).

The driving motor 50 may be driven by receiving electric energy and may include a front wheel motor 51 for rotating the front wheels and a rear wheel motor 52 for rotating the rear wheels. The front wheel motor 51 and the rear wheel motor 52 may be driven individually by receiving different torque. That is, the magnitude and rotation direction of the torque of the front wheel motor 51 may be different from the magnitude and rotation direction of the torque of the rear wheel motor 52.

The display 60 may be used to display image information about virtual driving received from the user terminal 200. The display 60 may be placed in the cluster of the vehicle VEH, and may be implemented in the form of a liquid crystal display (LCD) or an organic light emitting diode display (OLED). Furthermore, the display 60 may be an augmented reality-based display device such as a head-up display (HUD).

The user terminal 200 may be used to perform virtual driving based on the driver input and may be installed in a driving application for the virtual driving. The driving application may perform the virtual driving based on the driver input and may determine virtual driving information of the vehicle based on the virtual driving. For example, the driving application may be a car racing game, or the like.

The user terminal 200 may provide an index signal to the vehicle VEH while the virtual driving is in progress. The index signal may be used to provide a notification of the start and progress status of the virtual driving, and may be a signal of which the value periodically increases. For example, the index signal may be a signal of which the value periodically increases.

The virtual driving information generated by the user terminal 200 may include gear information, Z-axis movement information, impact amount, image information, or the like. The gear information may include information indicating the stage of a gear and may be generated based on the APS signal of the driver input. The Z-axis movement information may indicate the extent to which a vehicle moves in a Z-axis direction while virtually driving on a map provided by the driving application of the user terminal 200. The Z-axis may mean a direction perpendicular to the ground. The impact amount may be calculated when a vehicle collides with another obstacle in virtual driving. The image information may be image data for providing a notification of a situation in which virtual driving is in progress, and may be generated based on the field of view of the driver of the vehicle performing the virtual driving.

The user terminal 200 may be a smart phone, a tablet PC, a laptop, or the like in which the driving application is capable of being stored.

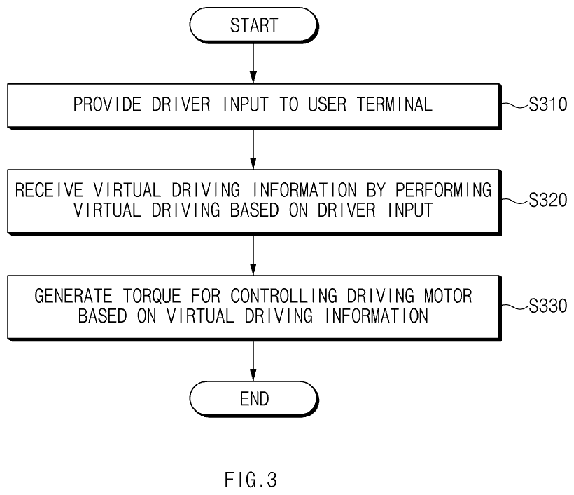

FIG. 3 is a flowchart for describing a vehicle control method, according to an embodiment of the present disclosure.

A vehicle control method according to an embodiment of the present disclosure will be described with reference to FIGS. 1 to 3.

In S310, the processor 30 may provide a driver input to the user terminal 200. The providing of the driver input to the user terminal 200 may include controlling, by the processor 30, the communication device 40.

The driver input may be received from the sensor 10. For example, the processor 30 may provide the user terminal 200 with steering angle information received from a steering angle sensor. Moreover, the processor 30 may determine required torque based on the signal received from an APS and may provide the required torque to the user terminal 200. The required torque may mean a torque command for driving the driving motor 50 in response to APS information.

In S320, the processor 30 may receive virtual driving information from the user terminal 200 through the communication device 40.

The virtual driving information may be information generated as the user terminal 200 performs virtual driving based on the driver input. The user terminal 200 may launch a driving application such as a racing game, and may perform virtual driving based on the driver input in a virtual driving environment provided by the driving application. The user terminal 200 may generate the virtual driving information including the result of the virtual driving and may provide the virtual driving information to the communication device 40 of the vehicle control apparatus 100.

The virtual driving information may include gear information, Z-axis movement information, and impact amount information. The gear information may include gear stage information of a virtual vehicle performing virtual driving based on the required torque received from the vehicle VEH. The Z-axis movement information may mean the Z-axis movement of the virtual vehicle while the virtual vehicle is driving based on the required torque and the steering angle information received from the vehicle VEH. The impact amount information may be calculated when the virtual vehicle collides with an obstacle in the virtual driving environment.

In S330, the processor 30 may generate torque for controlling the driving motor 50 based on the virtual driving information, and may control the driving motor 50 by using the torque.

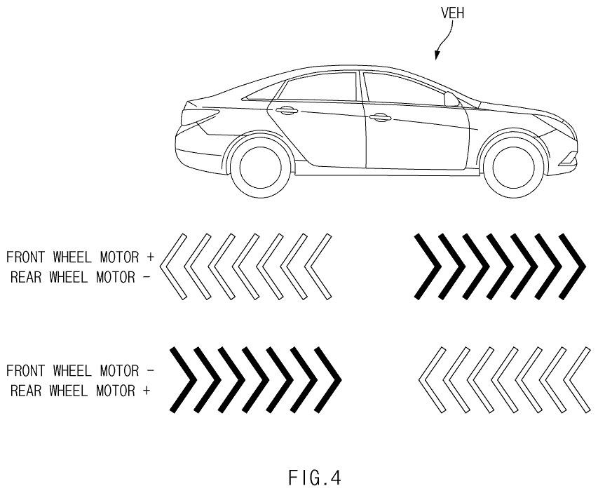

FIG. 4 is a diagram for describing a method in which a processor controls a driving motor.

Referring to FIG. 4, the processor 30 may control the driving motor 50 such that front and rear wheels rotate in opposite directions to each other. “+torque” may be used to rotate the driving motor 50 to move the vehicle VEH in a forward direction, and “−torque” may be used to rotate the driving motor 50 to move the vehicle VEH in a backward direction.

The processor 30 may provide “+torque” to the front wheel motor 51 and may provide “−torque” to the rear wheel motor 52. Alternatively, the processor 30 may provide “−torque” to the front wheel motor 51 and may provide “+torque” to the rear wheel motor 52.

The vehicle VEH may move vertically without moving longitudinally by rotating the front and rear wheels in opposite directions to each other. Accordingly, an occupant of the vehicle VEH may experience the bounce of the vehicle VEH. That is, the occupant of the vehicle VEH may identify that a specific event occurs during a virtual driving process, through the bounce of the vehicle VEH, thereby experiencing dynamic virtual driving.

Hereinafter, a vehicle control method according to an embodiment of the present disclosure will be described in more detail.

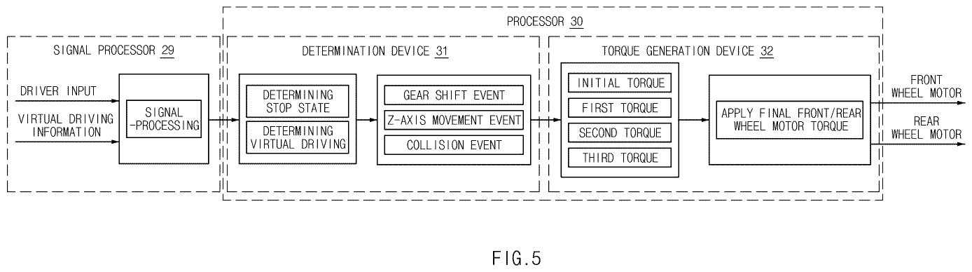

FIG. 5 is a drawing for describing an operation of a processor, according to an embodiment of the present disclosure.

The processor 30 according to an embodiment of the present disclosure may include a determination device 31 that determines an event based on signals received from a signal processor 29, and a torque generation device 32 that controls torque in response to the event.

The signal processor 29 may perform signal-processing on a driver input received from an occupant of the vehicle VEH and virtual driving information received from the user terminal 200 and may provide the processed result to the processor 30.

The determination device 31 of the processor 30 may determine whether to enter a virtual driving mode and may detect the event in the virtual driving mode. The event may be used as a trigger for initiating torque control of the driving motor 50 for the bounce effect of the vehicle VEH.

The determination device 31 may enter the virtual driving mode based on the user terminal 200 performing virtual driving in a state where the vehicle VEH is parked on a flat surface.

To determine whether the vehicle VEH is stopped on a flat surface, the determination device 31 may identify an inclination sensor and vehicle speed. For example, when the incline of the vehicle VEH is below a specific level, the determination device 31 may determine whether the vehicle VEH is located on flat ground. The inclination of the vehicle VEH may be determined based on the acceleration and angular velocity of the vehicle VEH in addition to an inclination sensor of the sensor 10.

The determination device 31 may identify vehicle speed to determine whether the vehicle VEH is stopped, and may determine that the vehicle VEH is stopped, based on the vehicle speed being 0 (zero).

Moreover, the determination device 31 may determine whether virtual driving of the driving application is performed, based on an index signal received from the user terminal 200. The index signal may be a signal whose value periodically changes. For example, the index signal may be a signal of which the level increases sequentially from 0 to 255 at regular intervals. During a virtual driving period, the user terminal 200 may continuously transmit an index signal. The determination device 31 may identify that virtual driving is started, based on changes in the index signal being detected during a specific time. Furthermore, the determination device 31 may identify that virtual driving is performed, based on the index signal being changed. The determination device 31 may identify that the virtual driving is stopped, based on the index signal not being changed during a specific time.

The event may include a gear shift event, a Z-axis movement event, a collision event, or the like.

The gear shift event may be an event that occurs when a gear shift is detected during virtual driving. The determination device 31 may determine a gear shift event based on a vehicle speed change of the vehicle VEH and gear information of the virtual driving information. The vehicle speed change of the vehicle VEH may be determined based on the acceleration position signal of the driver input. For example, when the vehicle speed of the vehicle VEH is greater than or equal to threshold speed and the gear information of the virtual driving information is a neutral gear, the determination device 31 may determine that a gear shift occurs in the virtual driving. Because the stage of a gear in the gear shift requires passing through a neutral state, the determination device 31 may determine whether to shift a gear when a neutral gear state is identified in the virtual driving information.

A method in which the determination device 31 detects a gear shift may be implemented in various other embodiments.

The Z-axis movement event may be an event that occurs when it is detected that a virtual vehicle performing virtual driving moves in a Z-axis direction. The determination device 31 may identify the Z-axis movement of the virtual vehicle from the virtual driving information, and may determine the Z-axis movement event based on the magnitude of the Z-axis movement of the virtual vehicle.

The collision event may be an event detected when the virtual vehicle performing virtual driving collides with an obstacle. The determination device 31 may identify a collision of the virtual vehicle from the virtual driving information and may determine the collision event based on a collision amount of the virtual vehicle.

The torque generation device 32 of the processor 30 may control the driving motor 50 to induce a motion impact in response to the determination device 31 detecting an event.

As described above, the control of the driving motor 50 for a motion impact may correspond to rotating the front wheel motor 51 and the rear wheel motor 52 in opposite directions to each other.

Moreover, according to an embodiment, in the virtual driving mode, the processor 30 may restrict the driving motor 50 from being driven based on driver-required torque. The driver-required torque may be a torque command of the driving motor 50 generated in proportion to an acceleration position signal.

When a mode is not the virtual driving mode, the acceleration position signal obtained by the driver input may be transmitted to a vehicle control unit (VCU), and the VCU may determine the driver-required torque based on the acceleration position signal. Furthermore, the driving motor 50 may be driven based on the driver-required torque to induce the vehicle VEH to move in a longitudinal direction. In the virtual driving mode, an operation of restricting the operation of the driving motor 50 based on the driver-required torque may be restricting one or more of procedures among procedures for moving the vehicle VEH in the longitudinal direction. For example, the processor 30 may block the acceleration position signal from being sent to the VCU, or the VCU may restrict a procedure for delivering the driver-required torque to the driving motor 50.

Also, according to an embodiment, the processor 30 may maintain the gear in D gear in the virtual driving mode. In a process of changing the torque of the driving motor 50 by motion impact drive, a feeling of engagement may occur due to the transmission. The gear may be maintained in D gear in the virtual driving mode to prevent the feeling of engagement of the transmission.

Moreover, according to an embodiment, the processor 30 may generate an initial torque for backlash prevention in the virtual driving mode. The initial torque may be provided to the driving motor 50 in the virtual driving mode even when no motion impact driving is performed. A direction of initial torque provided to the front wheel motor 51 may be opposite to a direction of initial torque provided to the rear wheel motor 52.

The processor 30 may be a computer-readable recording medium mounted on a single integrated circuit. Alternatively, the determination device 31 and the torque generation device 32 illustrated in FIG. 5 may be mounted on integrated circuits separate from each other.

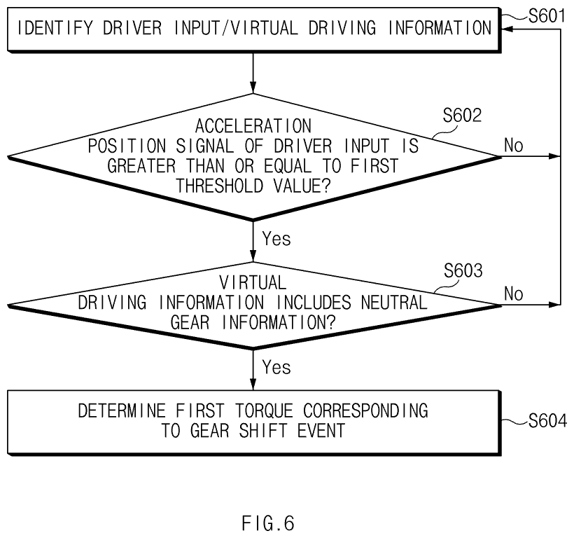

FIGS. 6 to 8 are drawings for describing a procedure for generating pieces of torque for motion impact driving.

FIG. 6 is a flowchart for describing a procedure for generating first torque.

Referring to FIG. 6, in S601, the processor 30 may identify an acceleration position signal of the driver input and virtual driving information received from the user terminal 200.

In S602 and S603, the processor 30 may determine the level of the acceleration position signal and may determine whether the level of the acceleration position signal is greater than or equal to a first threshold value. Furthermore, when the level of the acceleration position signal is greater than a second threshold value, the processor 30 may determine whether the virtual driving information includes neutral gear information.

As the external force applied to an accelerator increases, the acceleration position signal may be set to be increased.

The processor 30 may determine that a gear shift event occurs, based on the level of the acceleration position signal being greater than or equal to a threshold value and the virtual driving being in a neutral gear.

In S604, the processor 30 may generate first torque in response to a gear shift event.

Because the first torque is used to induce a motion impact in response to detection of the gear shift event, the first torque may be different from the driver-required torque determined in proportion to the acceleration position signal. That is, the first torque may be a predetermined magnitude and may not be set proportionally to the acceleration position signal.

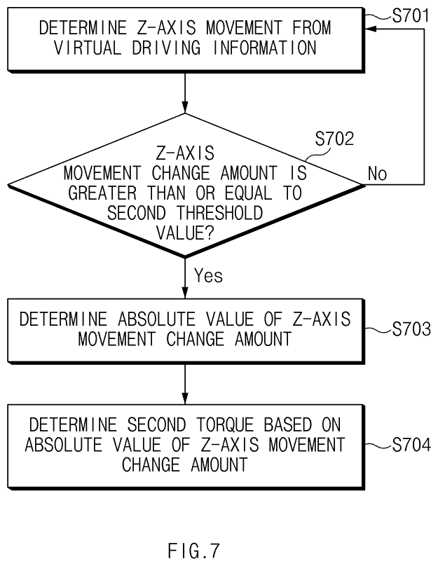

FIG. 7 is a flowchart for describing a procedure for generating second torque.

In S701, the processor 30 may identify Z-axis movement information from virtual driving information.

In S702, the processor 30 may determine a Z-axis movement change amount based on the Z-axis movement information. The Z-axis movement change amount may be obtained by calculating a change rate of the Z-axis movement amount by using a differentiator.

The processor 30 may compare the Z-axis movement change amount with a second threshold value.

When the Z-axis movement change amount is greater than or equal to the second threshold value, in S703, the processor 30 may determine the absolute value of the Z-axis movement change amount.

In S704, the processor 30 may determine second torque based on the absolute value of the Z-axis movement change amount.

According to an embodiment, the processor 30 may determine the second torque by reflecting a predetermined gain value to the absolute value of the Z-axis movement change amount.

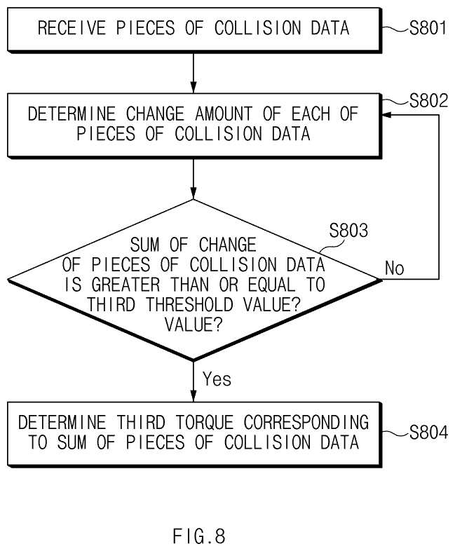

FIG. 8 is a flowchart for describing a procedure for generating third torque.

In S801, the processor 30 may identify collision data from virtual driving information.

The collision data may be used to providing a notification that a virtual vehicle collides with an obstacle, and may be data obtained by matching an impact amount with collision location data. The collision location data may be categorized depending on the area of the virtual vehicle. For example, the collision location data may include CDam0, CDam1, CDam2, CDam3, and CDam4, which are signals generated when impacts are applied to the front, rear, left side, right side, and center of the virtual vehicle, respectively. Accordingly, when impacts are applied to two or more locations on the virtual vehicle, two or more collision location data may be generated.

In S802, the processor 30 may identify an impact amount from the collision data and may determine a change amount of the impact amount.

The processor 30 may determine the change amount of the impact amount by using a differentiator.

In S803, the processor 30 may compare the sum of the change amount of the impact amount with a third threshold value.

The sum of the change amount of impact amount may mean the sum of the impact amounts matching the pieces of collision position data. For example, when the collision data includes CDam1 and CDam3, and the change amount of each impact amount is df1 or df3, the sum of the change amount of the impact amount may be calculated as “df1+df3”.

In S804, the processor 30 may determine the third torque corresponding to the sum of the change amount of the impact amount.

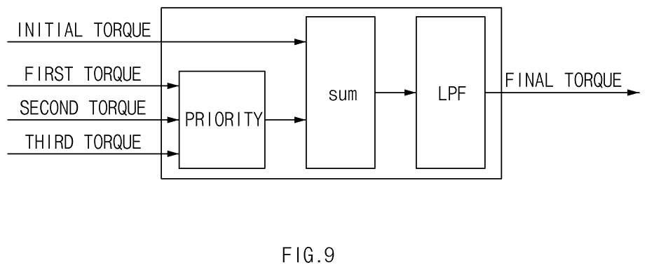

FIG. 9 is a drawing for describing a method for generating final torque for a motion impact. FIG. 9 may be a procedure performed by a processor.

Referring to FIG. 9, the processor 30 may identify first torque, second torque, and third torque, and may determine a priority. The priority may be predetermined and may also be adjusted by, for example, a user (e.g., an occupant of the vehicle VEH).

When the first torque, the second torque, and the third torque are received within a specific time, the processor 30 may select a piece or pieces of torque according to the priority. For example, when the effect of an impact event of a virtual vehicle is important, the processor 30 may preferentially select the third torque. A specific period may be set as a short period to be determined as simultaneous timing.

The processor 30 may add initial torque and torque selected in order of priority from the first torque, the second torque, and the third torque.

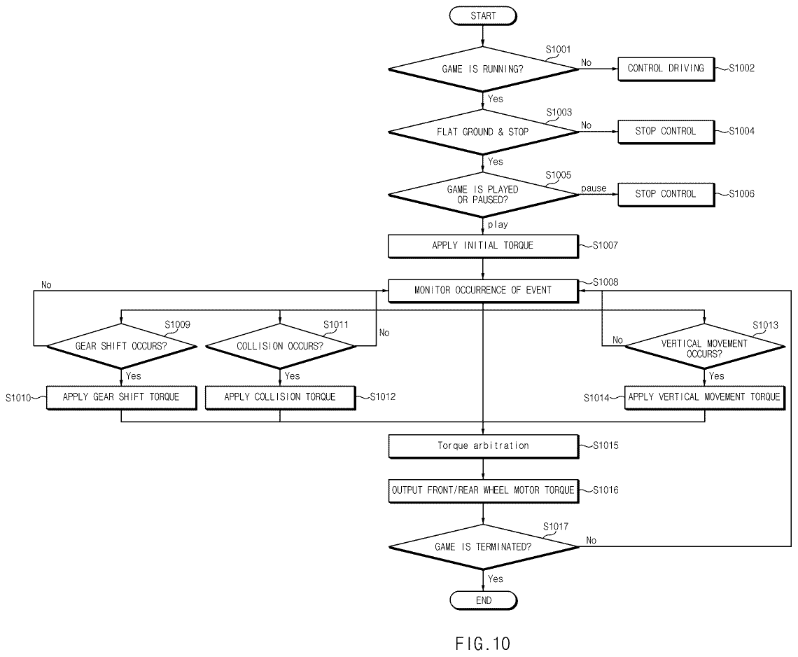

FIG. 10 is a flowchart for describing a vehicle control method, according to another embodiment of the present disclosure.

A vehicle control method according to an embodiment of the present disclosure will be described with reference to FIG. 10 as follows.

In S1001, the processor 30 may monitor whether a racing game is running on the user terminal 200.

The processor 30 may determine whether the racing game is running, by monitoring whether an index signal is received from the user terminal 200.

When the racing game is not running on the user terminal 200, in S1002, the processor 30 may control the driving of the vehicle VEH.

In S1003, the processor 30 may determine whether the vehicle VEH is stopped on a flat surface.

The processor 30 may determine whether the vehicle VEH is located on a flat surface, based on pieces of information identified through the sensor 10. Moreover, the processor 30 may determine whether the vehicle VEH is stopped, based on an accelerator input signal of the vehicle VEH.

When the vehicle VEH is not on a flat surface or is not stopped, in S1004, the processor 30 may stop the control. That is, the processor 30 may not perform a series of procedures for inducing a motion impact by controlling the driving motor 50 based on virtual driving even though the game is running.

In S1005, the processor 30 may determine whether the game is being played or paused, based on virtual driving information received from the user terminal 200.

When the game is paused, in S1006, the processor 30 may stop an operation of inducing the motion impact.

While the game is playing, in S1007, the processor 30 may remain in the virtual driving mode and may provide initial torque to the driving motor 50. The initial torque may be used to prevent backlash and may be set to rotate the front wheel motor 51 and the rear wheel motor 52 in opposite directions to each other.

In S1008, the processor 30 may monitor whether an event occurs.

The event may include a gear shift event, a collision event, and a Z-axis movement event.

In S1009 and S1010, the processor 30 may apply gear shift torque in response to detecting the gear shift event. A method for determining the gear shift torque may be the same as the method for determining the first torque described above.

In S1011 and S1012, the processor 30 may apply collision torque in response to detecting the collision event. A method for determining the collision torque may be the same as the method for determining the third torque described above.

In S1013 and S1014, the processor 30 may apply Z-axis movement torque in response to detecting the Z-axis movement event. The Z-axis movement may mean that the virtual vehicle is moving in a vertical direction. The Z-axis movement torque may be obtained according to a procedure for determining the second torque described above.

In S1015, the processor 30 may perform torque arbitration. The torque arbitration may mean determining the priority of the first torque, the second torque, and the third torque as described reference to FIG. 9.

In S1016, the processor 30 may control the front wheel motor 51 and the rear wheel motor 52 by using final torque determined based on the torque arbitration procedure.

In S1017, the processor 30 may terminate the virtual driving mode based on the game being terminated.

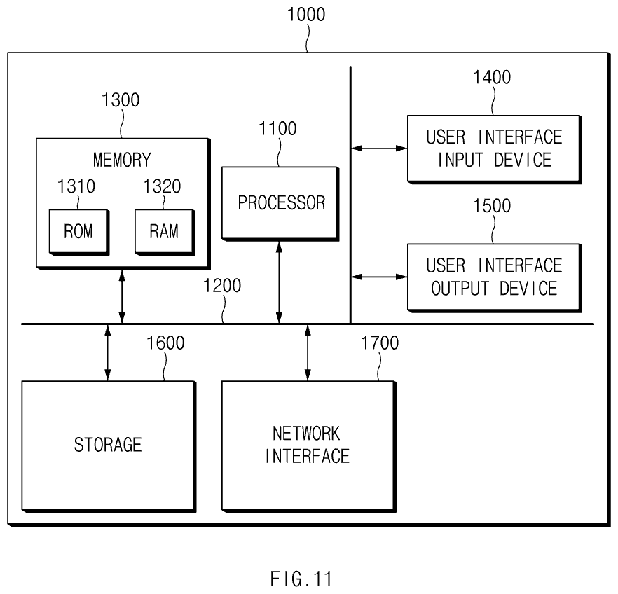

FIG. 11 illustrates a computing system according to an embodiment of the present disclosure.

Referring to FIG. 11, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and modifications may be made by one skilled in the art without departing from the essential characteristic of the present disclosure.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

According to an embodiment of the present disclosure, an occupant of a vehicle may experience the impact of a game running on a user terminal through motion control of the vehicle.

Moreover, according to an embodiment of the present disclosure, the occupant of the vehicle may enjoy the game with a high sense of immersion because he/she may feel the motion impact of the vehicle delivered through a driving motor of the vehicle.

Besides, a variety of effects directly or indirectly understood through the present disclosure may be provided.

Hereinabove, although the present disclosure was described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle control apparatus comprising:
a sensor mounted on a vehicle, the sensor being configured to sense a driver input; and
a processor configured to control a driving motor of the vehicle;
wherein the processor is configured to:
provide the driver input to a user terminal in a virtual driving mode;
receive, from the user terminal, virtual driving information obtained by performing virtual vehicle driving based on the driver input; and
generate torque configured to control the driving motor based on the virtual driving information.

2. The vehicle control apparatus of claim 1, wherein the processor is further configured to:
maintain the virtual driving mode based on an index signal, wherein a value of the index signal is configured to be changed at a specific interval while the virtual vehicle driving is running from the user terminal.

3. The vehicle control apparatus of claim 2, wherein the processor is further configured to:
restrict entry into the virtual driving mode based on a determination that the vehicle is driving, or that an incline of the vehicle is greater than or equal to a specific level.

4. The vehicle control apparatus of claim 1, wherein the processor is further configured to:
restrict the driving motor from being driven based on a driver-required torque in the virtual driving mode.

5. The vehicle control apparatus of claim 1, wherein the processor is further configured to:
perform a motion impact by controlling the driving motor such that a front wheel and a rear wheel of the vehicle rotate in opposite directions in the virtual driving mode.

6. The vehicle control apparatus of claim 5, wherein the processor is further configured to:
generate a first torque for the motion impact based on a determination that a gear shift is detected in the virtual vehicle driving.

7. The vehicle control apparatus of claim 6, wherein the processor is further configured to:
determine a Z-axis movement of the vehicle from the virtual driving information; and
generate a second torque for the motion impact based on the Z-axis movement.

8. The vehicle control apparatus of claim 7, wherein the processor is further configured to:
determine an impact amount from the virtual driving information; and
generate a third torque for the motion impact based on the impact amount.

9. The vehicle control apparatus of claim 8, wherein the processor is further configured to:
determine a preferred torque among the first torque, the second torque, and the third torque based on a predetermined priority; and
perform the motion impact based on the preferred torque.

10. The vehicle control apparatus of claim 9, wherein the processor is further configured to:
control the driving motor based on an initial torque during a period of the virtual driving mode; and
perform the motion impact by adding the initial torque and the preferred torque when the preferred torque is determined.

11. A vehicle control method comprising:
providing, by a processor, a driver input to a user terminal;
receiving, by the processor, virtual driving information, obtained by performing virtual vehicle driving based on the driver input, from the user terminal in a virtual driving mode; and
generating, by the processor, torque for controlling the driving motor of the vehicle based on the virtual driving information; and
controlling the driving motor of the vehicle based on the virtual driving information.

12. The method of claim 11, wherein the receiving of the virtual driving information includes:
maintaining the virtual driving mode based on an index signal, wherein a value of the index signal is changed at a specific interval while the virtual vehicle driving is running from the user terminal.

13. The method of claim 11, further comprising:
restricting entry into the virtual driving mode based on a determination that the vehicle is driving, or that an incline of the vehicle is greater than or equal to a specific level.

14. The method of claim 11, further comprising:
restricting the driving motor from being driven based on a driver-required torque in the virtual driving mode.

15. The method of claim 11, wherein the generating of the torque for controlling the driving motor of the vehicle based on the virtual driving information includes:
performing a motion impact by controlling the driving motor such that a front wheel and a rear wheel of the vehicle rotate in opposite directions.

16. The method of claim 15, wherein the performing of the motion impact includes:
generating a first torque for the motion impact based on a determination that a gear shift is detected in the virtual vehicle driving.

17. The method of claim 16, wherein the performing of the motion impact further includes:
determining a Z-axis movement of the vehicle from the virtual driving information; and
generating a second torque for the motion impact based on the Z-axis movement.

18. The method of claim 17, wherein the performing of the motion impact further includes:
determining an impact amount from the virtual driving information; and
generating a third torque for the motion impact based on the impact amount.

19. The method of claim 18, wherein the performing of the motion impact further includes:
determining a preferred torque among the first torque, the second torque, and the third torque based on a predetermined priority; and
performing the motion impact based on the preferred torque.

20. The method of claim 19, wherein the performing of the motion impact further includes:
controlling the driving motor based on an initial torque during a period of the virtual driving mode; and
performing the motion impact by adding the initial torque and the preferred torque when the preferred torque is determined.
